(19) United States
(12) Patent Application Publication
(10) Pub. No.: US 2024/0006581 A1
(43) Pub. Date: Jan. 4, 2024

(54) FABRICATION PROCEDURE OF NON-BINDER BIO-BASED CARBON ELECTRODE FOR BATTERY AND SUPERCAPACITOR

(71) Applicant: UNIVERSITY OF NORTH TEXAS, Dallas, TX (US)

(72) Inventors: Sheldon Q. SHI, Dallas, TX (US); Jiyao HU, Dallas, TX (US); Xuan WANG, Dallas, TX (US)

(21) Appl. No.: 18/345,439

(22) Filed: Jun. 30, 2023

Related U.S. Application Data
(60) Provisional application No. 63/357,766, filed on Jul. 1, 2022.

(51) Int. Cl. H01M 4/04; H01M 4/583

(52) U.S. Cl. CPC H01M 4/0471; H01M 4/583; H01M 2004/021

(57) ABSTRACT

A method for forming a carbon electrode can include forming a blank comprising a bio-based material, constraining the blank, pyrolyzing the blank, and forming a carbon electrode based on pyrolyzing the blank. The method can also include activating the carbon electrode during the formation of the carbon electrode or thereafter. The bio-based material can include wood, coconut shell, bamboo, rice husks, hemp, jute, or any combination thereof.

### CROSS-REFERENCE TO RELATED APPLICATIONS

This application claims priority to U.S. Provisional Application No. 63/357,766 filed on Jul. 1, 2022 and entitled, “A FABRICATION PROCEDURE OF NON-BINDER BIO-BASED CARBON ELECTRODE FOR BATTERY AND SUPERCAPACITOR,” which is incorporated herein by reference in its entirety.

### STATEMENT REGARDING GOVERNMENTALLY SPONSORED RESEARCH OR DEVELOPMENT

This invention was made with government support under Grant 2017-67021-26138 awarded by the USDA. The government has certain rights in this invention.

### BACKGROUND

The current trend in renewable energy applications requires improved electrical energy storage devices. While renewable energy production facilities create fewer carbon emissions, those that use wind or solar power may have challenges in maintaining steady power production. For example, when there may be fluctuations in power production due to overcast weather at a solar facility, or varying wind speeds at a wind farm. To address this issue, many power grids are turning to battery technologies such as lithium-ion rechargeable batteries to store energy from renewable sources and balance power production during peak demand periods.

However, these batteries are expensive and may not have a sufficient battery life or cycle time to be used on a large scale. Since the amount of charge is related to the number of electrons (or metal ions) that can be stored on the surface, a high surface area material is important for capacitors and batteries.

### SUMMARY

In some embodiments, a method for forming a carbon electrode comprises forming a blank comprising a bio-based material, constraining the blank, pyrolyzing the blank, and forming a carbon electrode based on pyrolyzing the blank. The method can also include activating the carbon electrode during the formation of the carbon electrode or thereafter. The bio-based material can include wood, coconut shell, bamboo, rice husks, hemp, jute, or any combination thereof.

In some embodiments, a carbon electrode comprises a pyrolized sheet of a bio-based material that is free of binders and is an activated carbon. The pyrolized sheet can have a BET surface area of greater than or equal to 1,000 m2/g, a tensile strength of greater than or equal to 0.09 N/mm2, and a specific capacitance of at least about 50 mF/g.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description:

FIG. 1A-1B illustrate examples of cutting options for the purpose of producing thin layer activated carbon for electrodes according to some embodiments.

FIG. 2 illustrates an example of metal meshes as constraints and the placement of samples inside a carbonization furnace.

FIG. 3 illustrates biocarbon product with no binder.

FIGS. 4A-4B illustrate images of blank formed from hemp, with the images showing hemp boards before (FIG. 4A) and after (FIG. 4B) activation. The top row contains 4 non-retted boards (a) and 2 low ret boards (b). The bottom half contains 2 med ret boards on the left (c) and 2 high ret boards on the right (d).

FIGS. 5A-5D illustrate a flexibility demonstration of the AC boards with a) non-retted AC board (FIG. 5A); b) low ret AC board (FIG. 5B); c) medium ret AC board (FIG. 5C); and d) high ret AC board (FIG. 5D).

FIGS. 6A-6D illustrate the results of tensile tests of hemp boards where FIG. 6A illustrates the Young's modulus of boards before activation, after carbonization, and after activation; FIG. 6B illustrates the Young's modulus of the AC of original boards, low ret boards, med ret boards, and high ret boards; FIG. 6C illustrates the ultimate stress of boards before activation, after carbonization, and after activation; and FIG. 6D illustrates the ultimate stress comparing the AC of original boards, low ret boards, med ret boards, and high ret boards.

FIGS. 7A-7J illustrate SEM images of AC boards from different retting conditions. Images in FIGS. 7A and 7B show non-retted AC boards; FIGS. 7C and 7D show low ret AC boards, FIGS. 7E and 7F show med ret AC boards; FIGS. 7G and 7H show high ret AC boards; and FIGS. 7I and 7J show high ret AC boards.

FIG. 8 illustrates a chart of the specific capacitance performance of electrodes made with or without PVDF binder.

### DETAILED DESCRIPTION

For electrodes, the amount of charge used with the electrode is related to the number of electrons that can be stored on the surface of the electrode material. Activated carbon (AC) is an inexpensive electrode material for batteries and supercapacitors with a high specific area, good thermal and electrical properties as well as being chemical stable. As a result, AC can be a preferred electrode material in supercapacitors and a variety of advanced batteries. In addition to electrode materials, applications for AC include hydrogen storage, air purification, capacitive deionization, solvent recovery, decaffeination, metal extraction, water purification, and medicine.

AC is a versatile carbon material that can offer unique morphological and chemical properties suitable for electrochemical storage applications. The properties of AC can be tailored by utilizing various precursors and adjusting activation parameters to meet specific requirements. In general, commercial ACs are often manufactured from petroleum and coal products under harsh reaction conditions, making them both costly and not environmentally friendly. The properties, such as small internal pore sizes and low total surface area for these commercial AC materials, are not suitable for batteries.

Recently, considerable progress has been made in the production of biocarbon, which is a type of AC derived from biomass, for use as electrochemical storage materials. Biocarbon typically possesses a high surface area and exhibits good electrical properties, making it a popular material for use in electricity and charge storage devices. Its ease of production, cost-effectiveness, and reasonable electrical properties have further contributed to its potential usefulness. The use of biomass as a precursor for AC provides several benefits such as low cost, sustainability, readily available, renewable, and reduced environmental impact compared to traditional AC produced from fossil fuels.

In some aspects, biocarbon can be produced by carbonizing and activating various types of biomasses, such as lignocellulosic materials such as agricultural waste, forestry residues, and municipal solid waste. Specific examples of biomass materials can include, but are not limited to, coconut shell, bamboo, rice husks, hemp, jute, natural fibers, as well as solid wood and wood chips, saw dust, and other construction scraps to produce AC. The electrochemical performance of the AC varies due to the different precursors and different activation conditions that introduce different functioning groups. The precursors' morphology, lignin content, and nano-level structure can also affect the AC's properties. The carbon derived from lignocellulosic fiber can produce self-supported and naturally ordered 3D structures with large surface area and conductivity which can form useful electrode materials used in advanced rechargeable batteries.

In some embodiments, the biomass useful in producing AC can comprise hemp or fibers derived from hemp. Industrial hemp (Cannabis sativa L.) is a fast-growing, renewable, and sustainable crop that can be cultivated without the use of pesticides or herbicides and is one of the oldest and most versatile crops. Hemp bast is a type of lignocellulosic material that contains carbohydrate polymers (cellulose and hemicellulose) and aromatic polymers (lignin), along with extractives. Hemp-derived AC can offer several advantages over other carbon materials. Hemp has a high surface area, which can be further enhanced by the activation process, resulting in AC with a high specific surface area and pore volume. Additionally, hemp biomass is abundant and cost-effective, making it an attractive alternative to other biomass materials. Using hemp biomass for AC production can also provide environmental benefits by reducing the dependence on non-renewable fossil fuel-derived materials. Overall, using hemp as a biomass material for AC production can provide several benefits such as high performance, sustainability, and resource efficiency, making it an attractive option for energy storage applications.

It can also be noted that the majority of current carbon-based electrodes use carbon powder mixed with binders. Binders are commonly used in the production of AC electrodes to improve their mechanical stability and prevent the active material from falling apart or delaminating during the manufacturing process or after repeated cycling of the electrodes. The most used carbon powder binders are polytetrafluoroethylene (PTFE), polyvinyl alcohol (PVA), polyvinyl butyral (PVB), polyvinylidene fluoride (PVDF), sulfosuccinic acid (SSA), and carboxymethyl cellulose (CMC). The binder increases the mechanical strength of the carbon-based electrodes so that they can be processed to form a battery. However, the addition of polymer binders not only increases the cost and weight of electrode, but also, more importantly, creates internal resistance and blocks the pores for the porous carbon resulting in diminished capacitance. By using binders, the capacitance of the resulting batteries decreases. The amount and type of binder material used in AC electrodes can significantly affect their electrochemical performance: the higher the binder content, the greater its impact on the battery performance. The elimination of additional binder materials can also reduce the cost and simplify the production process. Therefore, binder-free electrodes with excellent mechanical properties are desirable. Binder free electrodes should, in addition to the electrode having a good pore size and surface area, have a desired level of strength and flexibility so that it is manageable without fracturing during the battery manufacturing process.

Disclosed herein are activated biocarbon electrodes, which can also be referred to as bio-based carbon electrodes, that can be produced from biomass including lignocellulosic materials, such as wood, bamboo, hemp, and any bio-based composites. The biocarbon electrodes can be prepared using a pyrolysis process for carbonization and activation of the carbon. In some aspects, the electrodes can be produced as rectilinear shapes such as plates, but other structures can also be prepared. The resulting carbon electrode can have a well-integrated structure with a high surface area and pore structure which can be used for electrode applications in batteries and supercapacitors without using any binders or binding agents.

In some embodiments, the technology disclosed herein comprises a processing method to fabricate biocarbon electrodes without using binders, where the resulting electrodes can be used in batteries or supercapacitors. The feedstocks for the bio-based carbon feedstock or blanks can include bio-based materials including, but not limited to, lignocellulosic materials such as wood, bamboo, agriculture stems, hemp, or other bio-based composites. This process can include a whole-structural activation method. The process includes the bioproduct preparation, carbonization, and activation. The resulting bio-based carbon electrode can retain its structural integrity.

The first step in the process can include a bioproducts or biomass preparation step. In this step, the biomass sample can be prepared in a size and shape useful in the carbonization process. In some aspects, any woody plant material or lignocellulosic material can be used as the starting materials. For example, various carbon-based materials such as wood, bamboo, agriculture stems, hemp, biocomposites, and any other carbonaceous materials can be used as feedstocks. In some aspects, an amount of the material can be cut and shaped to form a blank that can correspond to the final electrode configuration while allowing for some changes in dimensions during the process.

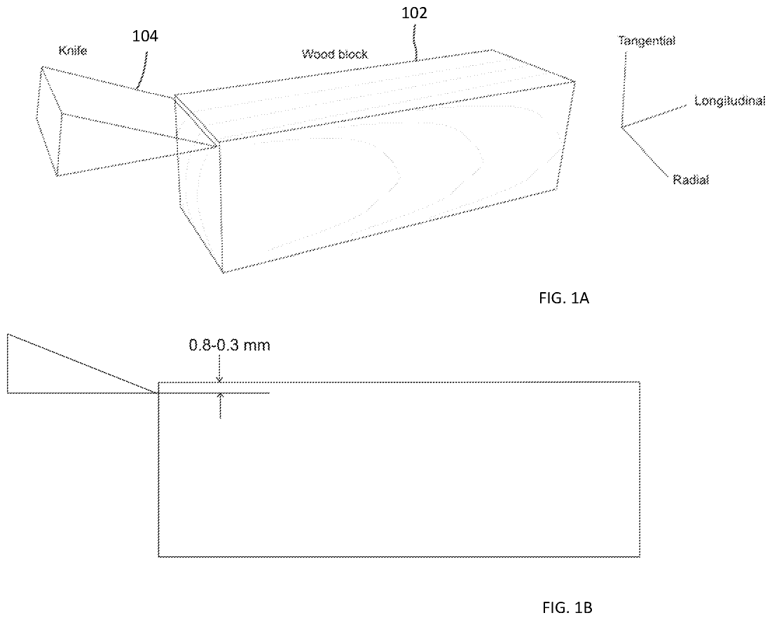

As an example, a blank in the form of a plate or sheet (e.g., a plate having a thickness of less than or about 1.0 mm) can be prepared using a cutting technique with a compression molding process. The bioproducts preparation for this whole-structural activation method can be used in producing a final structured activated carbon product. For example, a wood blocks can be cut flat and uniform in thickness for use in the process. As demonstrated in FIG. 1, the wood block 102 can be cut flat using a knife 104 or plane. The direction of the cut and resulting blank in the form of a sheet can determine the orientation of the fibers in the wood. In some aspects, the blank can be cut in the radial and longitudinal direction. This can result in the grains or fibers in the wood being oriented in the longitudinal direction of the blank. The resulting dimensions of the blank can also determine the final electrode dimensions. In order to obtain a thin electrode plate (e.g., less than about 1 mm, less than about 0.6 mm, or less than or equal to about 0.4 mm), the cut thickness of the wood blank can be to be controlled between about 1.5 to about 0.1 mm, or between about 1 mm to about 0.2 mm, or between about 0.8 mm and 0.3 mm. The carbonization and activation processes can reduce the thickness of the blank by 25% to 30% to form the final activated biocarbon electrode, and the original thickness can be selected to provide a desired final thickness of the electrode.

When the blank used in the carbonization process is formed from biomass fibers, the fibers can be prepared and formed into a desired shape to form the blank. As an example, hemp biomass can be retted into fibers with different retting processes depending on the amount of lignin to be removed. Retting refers to the process of breaking down the lignin in the biomass to separate the cellulosic and hemicellulosic fibers from the lignin. For low lignin removal (low ret), the hemp bast can be soaked in an aqueous fluid such as water for a time period between about 1 hr. to about 24 hours (e.g., between about 2 to about 8 hours) while mechanically stirring the mixture. For medium lignin removal (med ret), a bacterial retting process can be used. In this process, the bast fibers can be soaked in the bacteria containing solution for between 1 to 7 days, between about 2 to 5 days, or for about 3 days. For high lignin removal (high ret), a chemical retting process can be used. In this process, a heated reactor (operating at between about 120° C. to about 200° C., or at about 160° C.) can be used with basic solution (e.g., about 5% NaOH solution), and the fibers were retted for a time between about 0.5 to about 6 hours, or for about 1 h. After retting, a water wash (e.g., using purified or deionized water) can be used to wash the fibers until clean.

The retting process can result in separated fibers. In order to form a blank, the fibers can be arranged and formed into a blank. In some aspects, the fibers can be aligned in the blank, while in other aspects, the fibers can be woven, wrapped, or formed as a non-woven mass. The resulting fibers can then be pressed and heated to form a dried blank comprising pressed fibers. For example, the retted fibers can be formed into thin fiberboards having dimensions approximately the same as those for blanks cut from wood. The fibers can then be arranged and pressed for 30 min at 90° C. to remove the water.

While described as being formed as boards, wafers, or other rectilinear structures herein, other shapes such as rods, cylinders, sheets, and the like can also be formed from the biomass. The shape of the blank of biomass may be selected to correspond to a desired biocarbon form once the carbonization and activation processes are complete. In some aspects, the biocarbon can be formed as sheets, and once converted to activated biocarbon, be formed as rolled or otherwise processed electrodes using in electrochemical cells such as batteries.

The process for converting biomass to AC can comprise two steps: carbonization (e.g., pyrolysis, etc.) and activation. The initial carbonization step can convert the biomass in the blank to biochar through pyrolysis under an inert atmosphere, resulting in the removal of volatile components and the production of char or a carbonized blank with fixed carbon. In this process, the blanks can be placed in a reactor or furnace and heated to a desired temperature for a time between about 1 to about 24 hours, or between about 3 to about 8 hours. The pyrolysis process can occur at a range of temperatures such as from about 200° C. to about 1,100° C., from about 250° C. to about 1000° C., or from about 300° C. to about 900° C. A temperature ramping rate of less than about 1° C. per minute (° C./min), less than about 4° C./min, or less than about 10° C./min can be used to decrease the thermal stress experienced by the blanks during the carbonization process. In some embodiments, the pyrolysis process can occur at a pressure about atmospheric or less than atmospheric (e.g., under vacuum conditions). The atmosphere during the carbonization process can be inert and/or free from the presence of oxygen or other reactive gases. As described in more detail herein, the activation process can be performed after completion of carbonization, or in some aspects, along with the carbonization process. The carbonization process may be carried out at relatively mild conditions compared to current carbonization processes, including an activation agent is used with the blanks as part of the carbonization process.

The pyrolysis process can dissociate some portion of the hydrogen, oxygen, and other non-carbon atoms in the biomass to leave behind solid carbon. The structure of the remaining char can vary depending on the temperature and time used in the carbonization process, which can vary the degree and amount of volatile components and non-carbon atoms removed during the carbonization process. The resulting product can be solid char comprising carbon along with some amount of residual heteroatoms, with the remaining components forming a gas and leaving the pyrolysis reactor.

To prevent structural change during high temperature activation treatment, mechanical constraints such as weighted objects can be placed on top of the blanks to help retain the blank's shape during the pyrolysis process. The weighted objects can have a high temperature resistance, and be able to allow gas to pass through the surface. Any suitable constraint can be used and can be formed from metal, ceramic, particulates such as sand, or the like.

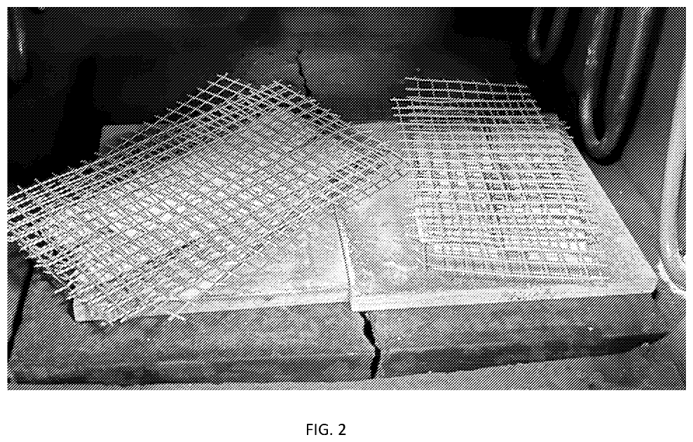

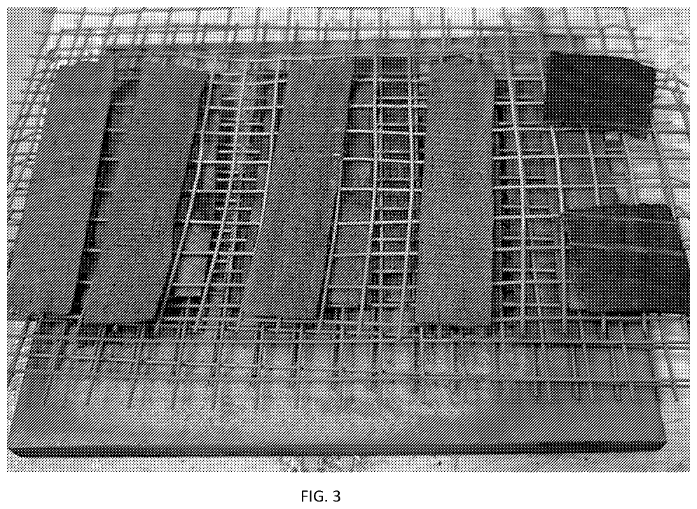

As an example, one such weighted object can be metal meshes as shown in FIG. 2. As illustrated, the blanks can be supported on a support than can withstand the pyrolysis temperature and have constraints such as one or more layers of a metal mesh placed on top of the blanks to retain the shape of the blank and/or shape the final carbonized product. The object being laid on top of the blank can have the following characteristics: it can have a hardness and stiffness (e.g., at pyrolysis temperatures) to retain the material in the desired shape; it can have a weight selected to be able to keep the carbon material in while not breaking the carbon material in the treatment process; it can have a melting temperature that is sufficiently high to avoid a phase changed during the high temperature treatment process; it can be chemically inert with respect to the carbon material and the chemical agents used; it can allow uniform activation temperature to be reached for the carbon material; it can allow any byproduct to escape from the carbon material without being damaged. The metal mesh shown in FIG. 2 is an example of such mechanical constraints used for blanks comprising thin layer wood material. The materials in Table 1 are examples of such materials with high melting temperature, which can be used as constraints. The positioning of the material being processed also can also be considered. A whole-structure activation method can rely on uniformity in the sample for the whole activation treatment process, thus samples can be to be placed in the middle of the heating vessel to reduce any unnecessary differences within the sample itself, in order to reduce structural damage to the samples. In some aspects, the pyrolysis furnace can be used with or without convective gas flow to help provide a uniform heating within the furnace or reactor.

TABLE 1
Melting temperatures of some materials capable
of being used as mechanical constraints.

| Metals | Fahrenheit (° F.): | Celsius (° C.): |
|---|---|---|
| Brass, Yellow | 1660-1710 | 905-932 |
| Bronze | 1675 | 913 |
| Brass, Red | 1810-1880 | 990-1025 |
| Copper | 1983 | 1084 |
| Cast Iron | 2060-2200 | 1127-1204 |
| Carbon Steel | 2500-2800 | 1371-1593 |
| Nickel | 2647 | 1453 |
| Wrought Iron | 2700-2900 | 1482-1593 |
| Stainless Steel | 2750 | 1510 |
| Titanium | 3040 | 1670 |

The resulting char can undergo an activation process to enlarge and develop the pores within the carbonized biochar, thereby increasing the internal surface area of the matrix. The activation process can use a chemical agent after the carbonization process, and/or a chemical agent can be used during the carbonization process to carry out the activation process and carbonization process in a single step. In the activation process, the chemical agent can comprise a solid, liquid, or gas that can be exposed or contacted with the blank or carbonized biomass. The activation agent can chemically alter the resulting carbon to produce the desired properties in the final biocarbon product.

In some aspects, the chemical activation agents can comprise one or more components that can be contacted with the blank or carbonized product to activate the resulting carbonized product. In some aspects, the chemical activation agents can include, but are not limited to, salts, acids, bases, hydroxides, and peroxides such as KOH, ZnCl₂, H₃PO₄, NaOH, H₂O₂, KMnO₄, NH₄NO₃, H₂SO₄, HNO₃, K₂SiO₃. These chemicals can be used to treat carbon materials before or during the high temperature treatment for the activation process. For example, the chemical agents can be contacted with the blank by spraying or soaking prior to pyrolysis. The resulting pyrolysis process can then both carbonize the biomass in the blank and activate the resulting carbonized product.

In some aspects, the blank can first be carbonized in the carbonization process. The resulting carbonized product can then be contacted with the chemical activation agents and subjected to a subsequent heating process to activate the carbonized blank. The subsequent heating process can be carried out under the same or similar conditions as the carbonization process, including the same temperature and atmosphere as the carbonization process.

In some aspects, the activation agent can be carried out using the presence of various gaseous agents, such as N₂, O₃, CO₂, water, steam, or a combination thereof. The gaseous agents can be used alone or in combination with any of the solid or liquid activation agents described herein. The gaseous agents can be introduced after carbonization, and/or as part of the carbonization process. For example, the blanks can be carbonized and then a gaseous agent can be introduced into the carbonization furnace to activate the carbonized blanks. Alternatively, the gaseous agents can be introduced into the carbonization furnace during the entire process. The activation process using the gaseous agents can be carried out under the same or similar conditions to those used for the carbonization process. For example, a continuous flow of CO₂ can be introduced into the carbonization reactor for 1-3 h to activate the resulting carbonized blank.

Overall, the pyrolysis process can convert the bio-based materials into activated biocarbon by pyrolyzing and activating the materials. This process can drive off a majority of the non-carbonaceous components such as oxygen, hydrogen, nitrogen, and the like. The resulting AC structure can then be used as an electrode. The biocarbon structure maintains a well-integrated structure and can be used directly in applications such as batteries and supercapacitors without the addition of any binding agent.

The specific properties of biomass-derived AC can be tailored by controlling the type of biomass, carbonization conditions, and activation method, allowing for the production of highly porous materials with specific surface areas and pore structures. One of the main properties of AC that give rise to its charge storage capability is its specific surface area. Brunauer-Emmett-Teller (BET) is a method used to characterize the specific surface area of a porous sample. The resulting AC can have a BET surface area of greater than 1,000 m²/g, or greater than about 1100 m²/g. The mechanical properties can include the tensile strength and Young's Modulus. In some aspects, the resulting AC can have a tensile strength of 0.09 N/mm², and a Young's Modulus of at least about 5 MPa, or at least about 6 MPa, or at least about 7 MPa. The electrical properties can include the capacitance, and in some aspects, the AC can have a specific capacitance of at least about 50 mF/g, at least about 100 mF/g, or at least about 125 mF/g.

The electrochemical performance of the resulting AC electrodes can be influenced by several factors that can affect their energy storage capacity, cycling stability, and rate capability. Some of the factors that affect the electrochemical performance of AC electrodes are surface area, pore size distribution, carbonization and activation conditions, binder materials, and electrolyte composition. Improving these factors can improve the electrochemical performance of AC electrodes, leading to better energy storage capacity, cycling stability, and rate capability. However, achieving a balance of these factors requires careful design and control of the manufacturing process.

### EXAMPLES

The disclosure having been generally described, the following examples are given as particular embodiments of the disclosure and to demonstrate the practice and advantages thereof. It is understood that the examples are given by way of illustration and are not intended to limit the specification or the claims in any manner.

### Carbonization and Activation

The fiberboards were carbonized in a vacuum furnace under vacuum at different temperatures for 3-8 h. The range of temperatures was 600-1,000° C. to explore the optimum temperature for carbonization. To ensure that the fiberboards did not deform in the furnace, light iron meshes (<20 g) were put on top to mechanically stopping the fiberboards from bending, and a slow ramping rate of 2° C./min was used to decrease the thermal stress experienced by these fiberboards. After carbonization, these fiberboards were then further activated at the same temperature as carbonization in the furnace with a continuous flow of CO₂ for 1-3 h.

### Activated Fiberboards Surface Area

One of the main properties of AC that give rise to its charge storage capability is its specific surface area. Brunauer-Emmett-Teller (BET) is a method used to characterize the specific surface area of a porous sample. The BET surface area was measured for the specimens after carbonization and after activation using Micromeritics 3Flex Surface and Catalyst Characterization instrument (Micromeritics, Norcross, GA) under nitrogen condition. As in other physical gas adsorption methods, an inert gas such as nitrogen is introduced to the material and adheres to the surface of any pores inside this material. An equation for the adsorption isotherm is then used to calculate surface area of a solid. This can provide the basis to gauge how much internal volume in total a sample possesses, and the results can provide a rough estimate as to the charge storage potential an AC material has.

### Activated Fiberboards Mechanical Properties

The mechanical properties of these fiberboards were measured using a tensile test done with Shimazu Universal Testing Machine. The test involves applying a gradually increasing uniaxial tensile force to a specimen until it fractures or breaks. From the tensile test, the ultimate tensile strength was obtained by checking the maximum stress before failure, and the Young's modulus was calculated by using MATLAB to calculate the slope of the stress vs strain curve's linear elastic region.

### Electrical Performance

Cyclic voltammetry is an electrochemical technique that is used to test the capacitance of the electrodes produced. The specific capacitance values of these activated fiberboards were measured using the CHI600e. A two-electrode system was used in aqueous 6M KOH electrolyte for basic electrochemical analysis. Graphite was used as current collector; the voltage window was set to be from −1V to 1V; the scan rate was 0.01 V/s; and sample interval was 0.001V. Using the equation below, specific capacitance can then be calculated on the sample to gauge how much charge the AC electrode can store, and thus estimate its performance in any electrochemical storage system.

$$C s = \frac{4 \int I \times dv}{um Δ V}$$

Where Cs is the specific capacitance in F/g, I is current, u is the scan rate in mV/s, m is mass in grams, and V is the voltage window.

### Results and Discussion

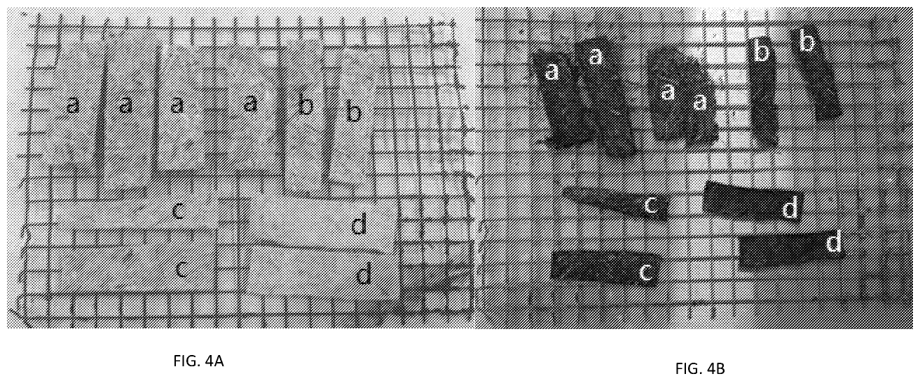

The hemp fibers were successfully retted, and the more retted fibers appear whiter in color compared to original non-retted fibers (FIGS. 4A and 4B). The retted fiber boards were then successfully activated in furnace. The boards without any retting show most degradation after activation, and small strands easily fall off of the main piece, while the high ret samples appear smoother.

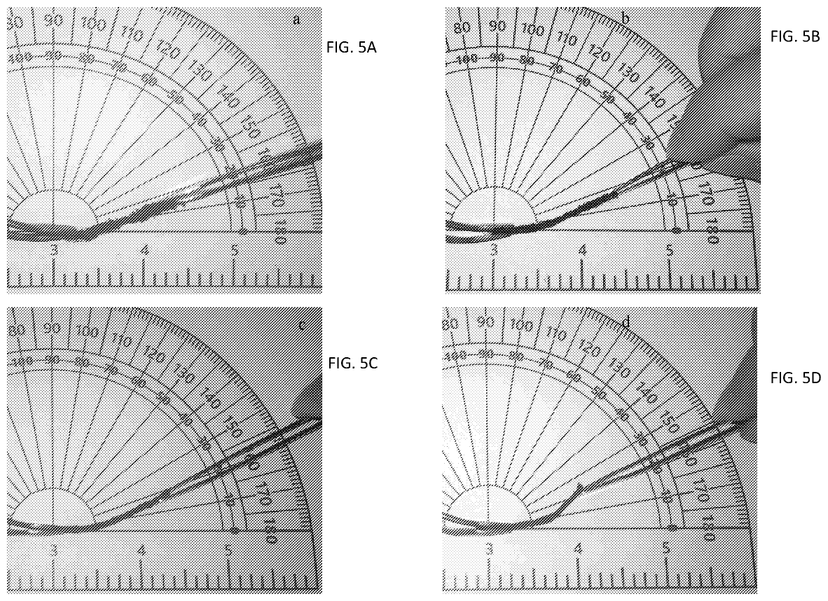

Since for battery purposes, the electrodes typically have to be thin, at below 0.5 mm in thickness, but if the boards are too thin, they crumble and become powder-like after activation. The boards were thus made with varying thickness to test for the best original board's thickness. It is found that the activation typically will reduce the thickness by 25% to 30%, and thus an original thickness of 0.8 mm was chosen for subsequent experiments. The boards with this thickness were able to maintain their structure while resulting in thickness of less than 0.5 mm, and as shown in FIGS. 5A-5D, can be flexible without the use of binders.

The carbonization and activation conditions were explored with the aid of BET measurements. The surface area of AC electrodes is a critical factor that affects their energy storage capacity. Since higher surface area allows for greater charge storage, leading to higher specific capacitance, a BET surface area of greater than 1,000 m²/g is desired. BET results (Table) show that with physical activation, at 800° C., the highest BET value is less than 400 m²/g, regardless of activation time. At 950° C., the BET value would increase from around 400 m²/g to 1400 m²/g if the activation time was increased from 3 to 5 h, which suggests the presence of activation after 3 h. However, for the board materials, at above 850° C., the activated materials become brittle and powder-like regardless of activation time. Thus, CO₂ activation at a lower temperature was used instead. The BET values increased from 500 to 1100 m²/g when CO₂ activation time increased from 60 to 90 min. Thus, the carbonization and activation conditions were optimized to be carbonization at 800° C. for 3 h and CO₂ activation at 800° C. for 90 min that would satisfy the BET requirement of greater than 1000 m²/g and could produce AC boards that are structurally sound.

TABLE 2
BET results of the AC from hemp boards obtained
at different retting conditions

| | | t-plot micropore | BJH mesopore |
|---|---|---|---|
| Samples | BET (m²/g) | area (m²/g) | area (m²/g) |
| Non-ret | 712.9484 | 139.1499 | 488.325 |
| high ret | 1094.0611 | 564.7512 | 450.2201 |
| med ret | 1185.5305 | 246.2722 | 863.4232 |
| low ret | 1301.8612 | 272.7992 | 910.5142 |

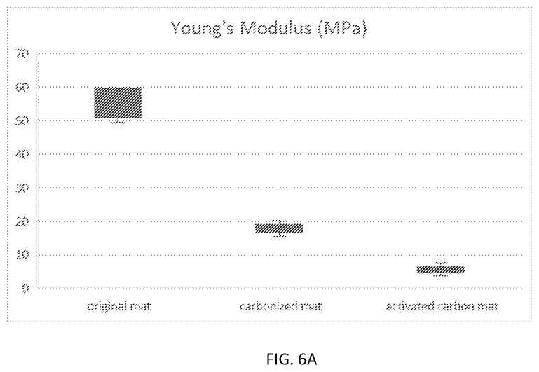

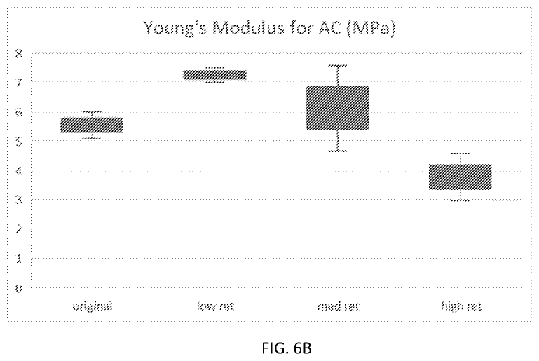

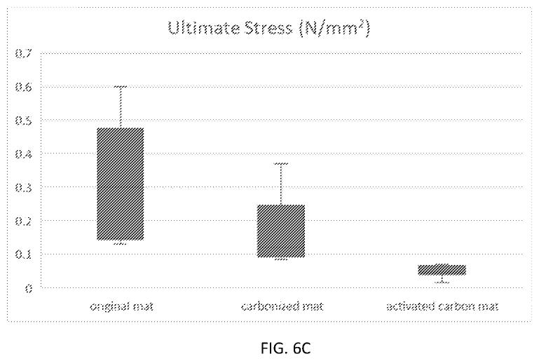

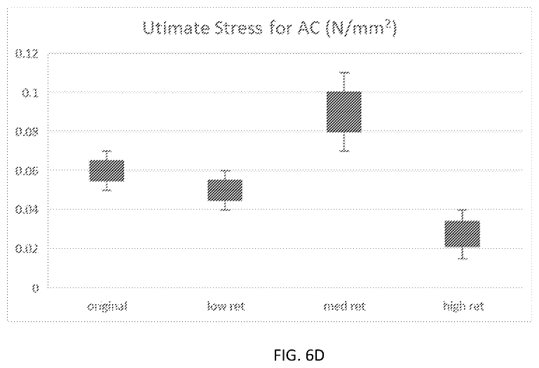

There are several requirements of the electrodes for battery and supercapacitor, one of these requirements is that the electrode needs to have some degree of strength and flexibility so that the electrodes do not break during manufacturing, transportation, and usage. The tensile tests (FIGS. 6A-6D) show that although the carbonization and activation significantly decreased the Young's modulus of the boards, from average 55 MPa for original boards to average 18 MPa for carbonized boards and average 5 MPa for activated boards, the retting conditions did not significantly affect the Young's modulus of the AC boards. Similarly results with ultimate stress. Carbonization and activation significantly decreased the ultimate stress. For activated boards, the med retted mat was found to have the highest ultimate stress. This could be due to the internal structural difference between the different retting materials, but since BET values did not find there was any significant specific surface area differences, SEM images were then used to visually inspect the reasoning for this difference.

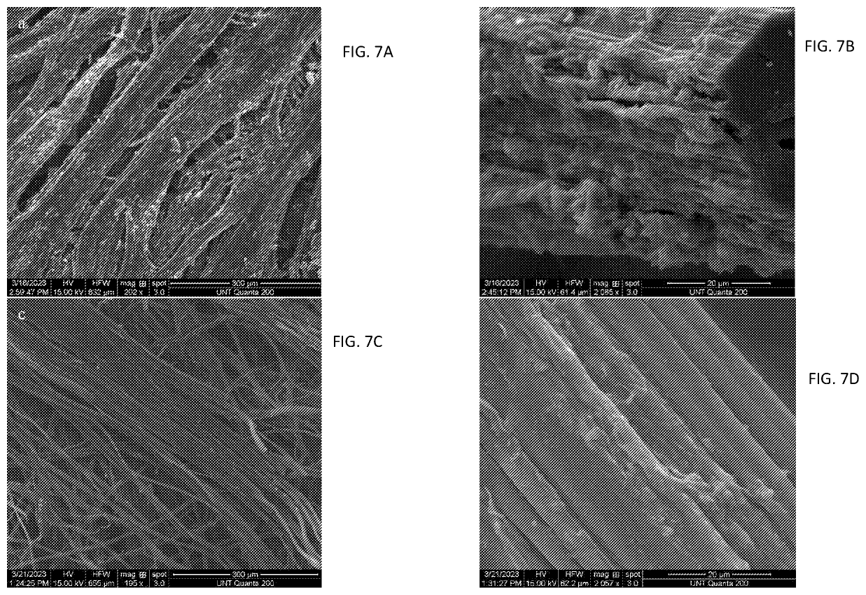

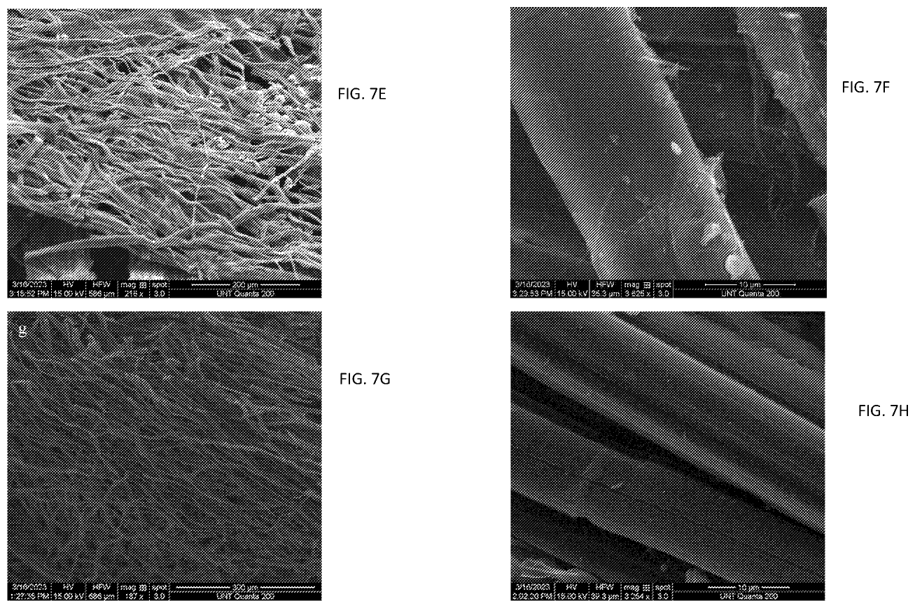

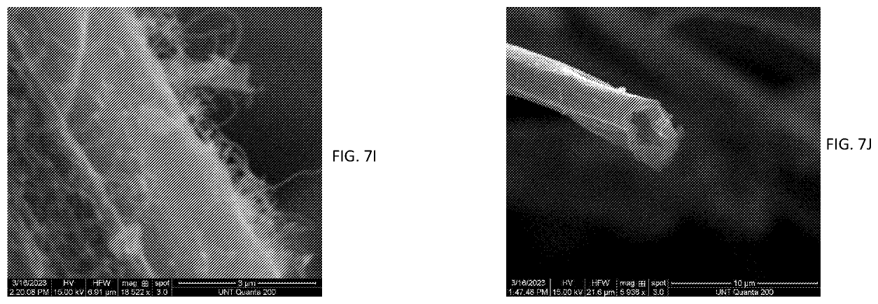

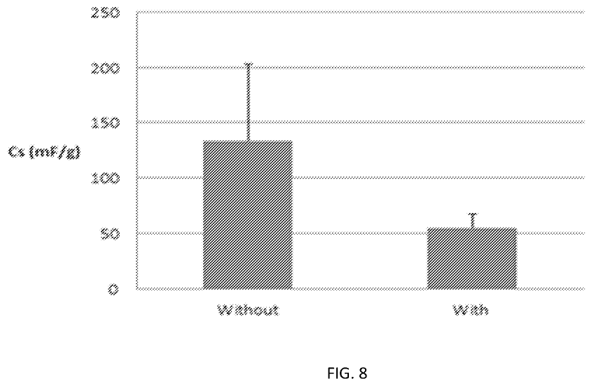

SEM images shown in FIGS. 7A-7J show that compared with retted fibers, the non-retted fibers appear more clumped together (FIG. 7A), and with more retting, the hemp fibers are consistently getting smoother (FIGS. 7B, 7D, 7F, and 7H). This is consistent with the retting treatment in that more retting means less lignin content, which would translate to less linkage between the hemp fibers. This lack of linkage between the fibers also opened more space, as suggested by the BET results of retted AC fibers having more surface area than non-retted AC fibers. With low retted AC fibers, the retting opened the connections between the fibers enough for pocket forming and ion access. However, with more retting, the fibers are completely separated from each other, and no ion storage pockets can be formed, which explains the decreasing trend of BET surface area from low retted samples to high retted samples. Some areas of the high retted fibers show activated cellulous microfibrils on the surface, which is also due to retting (FIG. 7I), because in the absence of lignin, these microfibrils can move more freely and thus could potentially be exploited to create a Velcro-like mechanical structures for structural integrity. The high retted samples also allowed for more CO₂ access to the fibers during activation, which allowed for the opening of micropores on the inside of the fibers (FIGS. 71 and 7J). These micropores can also be exploited to function as channels for electrolyte ions to move during electrode charging/discharging. Thus, future experiments should focus on making boards that combine the different retting properties in order to create AC boards that have both more BET area and more mechanical integrity and channel access.

Electrochemical results show that electrodes made with the traditional method of PVDF binder mixing show a worse performance than that from AC fiber board electrodes made without the use of PVDF (Error! Reference source not found.). Since no polymer binders were added into the electrode, capacitance performance was increased. The AC boards also have sufficient mechanical strength and good flexibility in the electrode fabrication steps.

In this example, hemp fibers obtained from different retting processes were uniformly formed into fiber mats, which were compressed into thin boards without adding resin and chemicals. The natural fiber thin boards were carbonized and activated in a furnace to obtain hemp-derived AC board with high pore volume and surface area, with low (water) ret condition having the highest BET surface value of 1302 m²/g. In order to evaluate the manageability of the hemp-based AC board used as electrode for follow-up in battery manufacturing process, mechanical strengths of the obtained thin AC boards were tested. The med (bacteria) retted had the highest tensile strength of 0.09 N/mm². The obtained novel binder-free biobased electrode enhances charge transport and stores higher capacitance in a given mass of electrode, assisting in the creation of a greener future.

Having described various devices, systems, and methods, certain embodiment can include, but are not limited to:

In a first embodiment, a method for forming a carbon electrode comprises forming a sheet of a bio-based material; constraining the sheet; pyrolyzing the sheet; and forming a carbon electrode based on pyrolyzing the sheet.

A second embodiment can include the method of the first embodiment, wherein forming the sheet of the bio-based material comprises: cutting a flat block of the bio-based material to form the sheet, wherein the flat block is cut in a radial and longitudinal direction.

A third aspect can include the method of the first or second embodiment, wherein the sheet has a thickness between about 0.3 mm and about 0.8 mm.

A fourth aspect can include the method of any one of the first to third embodiments, wherein constraining the sheet comprises: placing a mechanical constraint on top of the sheet during the pyrolyzing.

A fifth aspect can include the method of the fourth embodiment, wherein the mechanical constraint comprises a porous material, a mesh, a screen, or any combination thereof.

A sixth aspect can include the method of the fourth or fifth embodiment, wherein the mechanical constraint has a melting point above a pyrolysis temperature of the sheet.

A seventh aspect can include the method of any one of the first to sixth embodiments, wherein pyrolyzing the sheet occurs at a temperature between about 600° C. and about 1,000° C.

An eighth aspect can include the method of any one of the first to seventh embodiments, further comprising: treating the sheet with an activation agent prior to pyrolyzing the sheet.

A ninth aspect can include the method of any one of the first to seventh embodiments, further comprising: treating the carbon electrode with an activation agent.

A tenth aspect can include the method of any one of the first to ninth embodiments, wherein the activation agent comprises at least one of KOH, ZnCl₂, H₃PO₄, NaOH, H₂O₂, KMnO₄, NH₄NO₃, H₂SO₄, HNO₃, K₂SiO₃, or any combination thereof.

An eleventh aspect can include the method of any one of the first to tenth embodiments, wherein pyrolyzing the sheet occurs in the presence of N₂, O₃, CO₂, steam, or any combination thereof.

A twelfth aspect can include the method of any one of the first to eleventh embodiments, further comprising: using the carbon electrode in a battery, capacitor, supercapacitor, fuel cell, or any combination thereof.

A thirteenth aspect can include the method of any one of the first to twelfth embodiments, wherein the carbon electrode and the sheet are free of binders.

In a fourteenth embodiment, a carbon electrode comprises a pyrolized sheet of a bio-based material.

A fifteenth embodiment can include the electrode of the fourteenth embodiment, wherein the sheet has a thickness of less than about 0.4 mm.

A sixteenth embodiment can include the electrode of the fourteenth or fifteenth embodiment, wherein the pyrolized sheet is treated with an activation agent, and wherein the activation agent comprises at least one of KOH, ZnCl₂, H₃PO₄, NaOH, H₂O₂, KMnO₄, NH₄NO₃, H₂SO₄, HNO₃, K₂SiO₃, or any combination thereof.

A seventeenth embodiment can include the electrode of any one of the fourteenth to sixteenth embodiments, wherein the pyrolized sheet is free of binders.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically, and by way of example, although the headings might refer to a “Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of the claims shall be considered on their own merits in light of this disclosure, but should not be constrained by the headings set forth herein.

Use of broader terms such as comprises, includes, and having should be understood to provide support for narrower terms such as consisting of, consisting essentially of, and comprised substantially of Use of the term “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

While preferred embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

1. A method for forming a carbon electrode, the method comprising:
forming a blank comprising a bio-based material;
constraining the blank;
pyrolyzing the blank; and
forming a carbon electrode based on pyrolyzing the blank.

2. The method of claim 1, wherein forming the blank comprises:
cutting a flat block of the bio-based material to form the blank, wherein the flat block is cut in a radial and longitudinal direction.

3. The method of claim 1, wherein the blank has a thickness between about 0.3 mm and about 0.8 mm.

4. The method of claim 1, wherein the bio-based material comprises wood, coconut shell, bamboo, rice husks, hemp, jute, or any combination thereof.

5. The method of claim 1, wherein forming the blank comprises:
retting biomass;
extracting natural fibers from the biomass based on the retting; and
forming the blank from the natural fibers.

6. The method of claim 1, wherein constraining the sheet comprises:
placing a mechanical constraint on top of the blank during the pyrolyzing.

7. The method of claim 6, wherein the mechanical constraint comprises a porous material, a mesh, a screen, or any combination thereof.

8. The method of claim 6, wherein the mechanical constraint has a melting point above a pyrolysis temperature of the sheet.

9. The method of claim 1, wherein pyrolyzing the blank occurs at a temperature between about 600° C. and about 1,000° C.

10. The method of claim 1, wherein pyrolyzing the blank occurs under a vacuum pressure.

11. The method of claim 1, further comprising:
treating the blank with an activation agent prior to pyrolyzing the blank.

12. The method of claim 1, further comprising:
treating the carbon electrode with an activation agent.

13. The method of 11, wherein the activation agent comprises at least one of KOH, ZnCl₂, H₃PO₄, NaOH, H₂O₂, KMnO₄, NH₄NO₃, H₂SO₄, HNO₃, K₂SiO₃, or any combination thereof.

14. The method of claim 1, wherein pyrolyzing the sheet occurs in the presence of N₂, O₃, CO₂, steam, or any combination thereof.

15. The method of claim 1, further comprising:
using the carbon electrode in a battery, capacitor, supercapacitor, fuel cell, or any combination thereof.

16. The method of claim 1, wherein the carbon electrode and the blank are free of binders.

17. A carbon electrode comprising:
a pyrolized sheet of a bio-based material, wherein pyrolized sheet is free of binders, and wherein the pyrolized sheet is an activated carbon.

18. The electrode of claim 17, wherein the sheet has a thickness of less than about 0.6 mm.

19. The electrode of claim 17, wherein the pyrolized sheet is treated with an activation agent, and wherein the activation agent comprises at least one of KOH, ZnCl₂, H₃PO₄, NaOH, H₂O₂, KMnO₄, NH₄NO₃, H₂SO₄, HNO₃, K₂SiO₃, or any combination thereof.

20. The electrode of claim 17, wherein the pyrolized sheet has a BET surface area of greater than or equal to 1,000 m²/g, a tensile strength of greater than or equal to 0.09 N/mm², and a specific capacitance of at least about 50 mF/g.
